(19) United States
(12) Patent Application Publication
(10) Pub. No.: US 2005/0227695 A1
(43) Pub. Date: Oct. 13, 2005

(54) Flow control method in a telecommunications system

(75) Inventors: Juha Rasanen, Espoo (FI); Mikko Ohvo, Numminen (FI)

Correspondence Address: PILLSBURY WINTHROP SHAW PITTMAN, LLP, P.O. BOX 10500, MCLEAN, VA, 22102, US

(73) Assignee: Nokia Corporation, Espoo (FI)

(21) Appl. No.: 11/149,180

(22) Filed: Jun. 10, 2005

Related U.S. Application Data
(63) Continuation of application No. 09/869,069, filed on Jun. 22, 2001.

(30) Foreign Application Priority Data
Jan. 15, 1999 (FI) 990071

(51) Int. Cl. H04Q 7/20

(52) U.S. Cl. 455/436

(57) ABSTRACT

The invention relates to flow control in data transmission in telecommunications systems, particularly in wireless telecommunications systems. In the present invention flow control information is tunnelled over a connection leg which does not support flow control on a lower transmission protocol layer underlying a user level. The nodes at the both ends of the leg are arranged to use the flow control information to control the data flow on the lower transmission protocol level of the leg. In other words, the transmission of new data on the lower transmission protocol level is ceased or the data rate decreased when the flow control information activates the flow control in the transmitting node, and similarly, the transmission of new data on the lower transmission protocol level is restarted or the data rate increased when the conveyed flow control information deactivates the flow control.

This is a continuation of U.S. patent application Ser. No. 09/869,069, filed Jun. 22, 2001, which is the U.S. National Stage of International Application No. PCT/FI00/00025, filed Jan. 14, 2000, which relies for priority upon Finnish Patent Application No. 990071, filed Jan. 15, 1999, the contents of all of which are incorporated herein by reference in their entireties.

### FIELD OF THE INVENTION

The invention relates to flow control in data transmission in telecommunications systems, particularly in wireless telecommunications systems.

### BACKGROUND OF THE INVENTION

Wireless communications systems refer generally to any telecommunications system which enables wireless communication between the users and the network. In mobile communications systems users are capable of moving within the service area of the system. A typical mobile communications system is a public land mobile network (PLMN).

The present third generation mobile systems, such as Universal Mobile Communications system (UMTS) and Future Public Land Mobile Telecommunications system (FPLMTS), later renamed as IMT-2000 (International Mobile Telecommunication 2000), are being developed. The UMTS is being standardized in the ETSI (European Telecommunication Standards Institute) whereas the ITU (International Telecommunication Union) is defining the IMT-2000 system. The radio interface is likely to be based on a wide band CDMA (Code Division Multiple Access), and therefore the third generation systems are often referred to as wide band CDMA systems (WCDMA). These future systems are basically very alike.

FIG. 1 shows a simplified UMTS architecture with external reference points and interfaces to the UMTS terrestrial radio access network, UTRAN. The UTRAN consists of a set of radio access networks RAN (also called radio network subsystem RNS) connected to the core network (CN) through the interface lu. These radio network subsystems can be interconnected together through an interconnection point (reference point) lur. The interfaces lu(s) and lur are logical interfaces. The lur can be converged over physical direct connection between RANs or via any suitable transport network. Each RAN is responsible for the resources of its set of cells. On each connection between a mobile station MS and the UTRAN, one RAN is a serving RAN. A RAN consists of a radio network controller RNC and a multiplicity of base stations BS. The RNC is responsible for the handover decisions that require signalling to the MS. The base stations are connected to the RNC through the lub interface. The core network CN is a conventional or future telecommunications network modified to efficiently utilize the UTRAN in wireless communication. Telecommunications networks that are thought to be suitable core networks include second generation mobile communications systems, such as GSM, and other telecommunications systems, such as ISDN (Integrated Services Digital Network), BISDN (Broadband ISDN), PDN (Packet Data Network), etc.

Transition to the use of third generation mobile systems will occur in steps. In the first step the 3G radio access network will be introduced into the 2G network infrastructure. Such a ”hybrid system” is illustrated by the RNC1 connected to a 2GMSC10 in FIG. 1. As the 3G radio access network will not be compatible to the 2GMSC, it is apparent that such a mixed architecture requires interworking between the 2G and the 3G elements. This interworking is typically depicted as an interworking unit (IWU), such as IWU 11 in FIG. 1. The general requirement is that no modifications are allowed in the 2G system (in the 2GMSC), and thereby the interface between the 2MSC and the IWU must be a pure A interface according to the GSM specifications. Later the development will result in a situation where pure 3G mobile systems exist side by side with the 2G mobile systems or the hybrid systems. In FIG. 1, the RNC2 and the third generation MSC12 illustrate a pure 3G system.

FIG. 2 illustrates protocol stacks which may be employed in a pure 3G mobile system. A traffic channel (the user plane) layer between the mobile station MS and the RNC uses a radio link control (RLC) protocol and the medium access control (MAC). The RLC provides a radio-solution dependent on a reliable link over the radio path. It takes care of segmentation and assembly of the data from and to the upper layer before and after transmission over the radio path, respectively, as well as of retransmissions. Under the RLC the MAC function controls the mapping of the RLC protocol data units (RLC-PDUs) into physical channels in the physical layer. The physical layer includes all the schemes and mechanisms used to make communication possible on the radio channel. These mechanisms include, for example, modulation, power control, coding and timing. Wide band CDMA (WCDMA) and time division CDMA (TD-CDMA) are mentioned as examples of multiple access methods which can be used in the radio interface.

In the interface lu between the radio network controller RNC and the mobile switching centre MSC or the IWU, a potential candidate for transfer technique is the ATM (Asynchronous Transfer Mode). The ATM transmission technique is a switching and multiplexing solution particularly related to a data link layer (i.e. OSI layer 2, hereinafter referred to as an ATM layer). In the ATM data transmission the end users' data traffic is carried from a source to a destination through virtual connections. Data is transferred over switches of the network in standard-size packets called ATM cells. The ATM cell comprises a header, the main object of which is to identify a connection number for a sequence of cells forming a virtual channel for a particular call. A physical layer (i.e. OSI layer 1) may comprise several virtual paths multiplexed in the ATM layer. The ATM layer contains an ATM adaptation layer (AAL) which enhances the service provided by the ATM layer to support functions required by the next higher layer. The AAL performs functions required by the user and control and management planes and supports the mapping between the ATM layer and the next higher layer. The functions performed in the AAL depend upon the higher layer requirements. At the moment there are three different types of AAL, namely type 1 AAL (AAL1), type 2 AAL (AAL2) and type 5 AAL (AAL5).

A further retransmitting and error correcting protocol (LAC, Link Access Control) may or may not be specified to be used between the MS and the RNC or between the MS and the MSC (or the IWU), as shown in FIGS. 2 and 3. The LAC, if any, may be similar to the radio link protocol (RLP) employed in the GSM system. The circuit switched leg from the MSC to the fixed network uses standard PSTN or ISDN protocols (e.g. ISDN V.120) or possibly some other protocols on a dedicated connection.

FIG. 3 illustrates protocol stacks in a hybrid system in which a 3G radio access is connected to a 2GMSC via an interworking unit (IWU). In this case the ATM connection is terminated in the IWU. The leg between the IWU and the 2GMSC uses standard GSM protocols (the interface A). The interface between the MS and the RNC as well as the interface lu are between the RNC and the IWU are similar to those described with reference to FIG. 1.

The data rates on the concatenated legs (e.g., MS-RNC, RNC-MSC, MSC-fixed network) may be different in a circuit switched data call. The legs may have different nominal rates due to the different capacity of the channels and/or various retransmission conditions may make the effective data rate of a leg lower than the nominal data rate. Retransmissions can take place both on the MS-RNC leg with the MAC/RLC protocol (and possibly with the LAC protocol) and on the MSC-fixed network leg with the V.120 protocol, for example. If the LAC is implemented between the MS and the MSC (or the IWU), retransmissions can take place on this leg too on a higher protocol level.

The MAC/RLC and LAC protocols and many fixed network protocols, such as V.120, have inherent flow control mechanisms. The flow control is used by a receiver at one end of the leg or connection to control the data transmission from a transmitter at the other end of the leg or connection. When the receiver is not able to process e.g. forward the data at the same speed as it is received from the leg or connection, the receiving buffer starts to fill up. In such a situation the receiver may send a flow control ON request to the transmitter, which goes into a ‘flow control active’ mode. In the ‘flow control active’ mode the transmitter ceases the transmission of new data to the receiver or decreases the data rate. Moreover, in case of concatenated legs, the transmitting end may also activate the flow control in the previous leg in order to avoid the filling up of the receiving buffer since it is not able to forward the received data in the ‘active flow control’ mode. As a result, the overflow of receiving buffers and discarding of user data can be avoided in each leg of the end-to-end connection and thereby over the whole end-to-end connection. As a result data integrity is also maintained.

However, no end-to-end connection related flow control is supported by the current ATM specifications. The ATM only supports flow control from the user to the network. If the flow control is active, the network discards cells instead of sending them to the user. Another flow control mechanism supported by the ATM is based on the recognition of a congestion in the network; in case of congestion lower priority cells are discarded by the network. The discarding of data will deteriorate the data integrity.

The fact that the end-to-end flow control is not supported by the ATM results in problems when the ATM is used in the interface lu between the RNC and the 3GMSC or the IWU, as shown in FIGS. 2 and 3. More particularly, one leg along the end-to-end connection consisting of various concatenated legs does not support flow control, and therefore the end-to-end flow control fails. Let us study the situation more carefully with respect to FIGS. 2 and 3. In case there is no LAC over any of the legs or the LAC is operating between the MS and the RNC only, the current flow control mechanisms cannot guarantee data integrity in a circuit switched data call in the 3G mobile network using the ATM connection between the RNC and the MSC (or the IWU). The flow control activated towards the ATM leg does not stop sending data from the sending entity but leads to an overflow of receiving buffers or to discarding of ATM cells carrying user data. In case the LAC is operating between the MS and the MSC (or the IWU), the current flow control mechanisms require a huge buffer (a whole LAC retransmission window) in the RNC to guarantee the data integrity in a circuit switched data call in the 3G network using the ATM connection between the RNC and the MSC (or the IWU). The flow control towards the ATM leg does not stop sending data from the sending entity but leads to an overflow of the receiving buffer or to discarding of ATM cells carrying user data. In the latter case the use of the huge buffer in order to maintain the integrity of the data is very impractical due to the memory requirements in the RNC. In any case this will not work at all if there is no LAC at all or the LAC operates only between the MS and the RNC.

A similar problem may be encountered in any telecommunications system in which one or more of the concatenated connection legs do not support flow control.

### DISCLOSURE OF THE INVENTION

An object of the invention is to overcome the above problems in the flow control in telecommunications systems.

An aspect of the present invention is a data transmission method in a telecommunications system, comprising the steps of
transmitting data over a connection comprising a first leg supporting flow control on a lower transmission protocol level underlying a user level, an intermediate second leg not supporting flow control on the lower transmission level, and a third leg supporting flow control on the lower transmission protocol level,
tunnelling lower level flow control information transparently over the lower transmission protocol level of the second leg between said first and third legs in order to provide end-to-end flow control and thereby data integrity over the connection on the lower transmission protocol layer.

Another aspect of the present invention is a telecommunications system, comprising
a first connection leg supporting flow control on a lower transmission protocol level underlying a user level,
an intermediate second connection leg not supporting flow control on the lower transmission level,
a third connection leg supporting flow control on the lower transmission protocol level,
a first node between the first and second legs,
a second node between the second and third legs,
the first and second nodes being arranged to tunnel lower level flow control information transparently over the lower transmission protocol level of the second leg between said first and third legs in order to provide end-to-end flow control and thereby data integrity over the connection on the lower transmission protocol layer.

In the present invention flow control information is tunnelled over the leg which does not support flow control on a lower transmission protocol layer underlying a user level. The nodes at the both ends of the leg are arranged to use the flow control information to control the data flow on the lower transmission protocol level of the leg. In other words, the transmission of new data on the lower transmission protocol level is ceased or the data rate is decreased when the flow control information activates the flow control in the transmitting node, and similarly, the transmission of new data on the lower transmission protocol level is restarted or the data rate is increased when the conveyed flow control information deactivates the flow control. The need of flow control may be recognized from the receiving buffer status on the lower transmission protocol level or from incoming flow control information received over the following leg of the connection in the downlink direction.

In order to implement the flow control, the flow control information may be employed by the user layer protocol entity. The user layer entity may implement the above flow control by controlling the data input from the user layer to the underlying lower transmission protocol layer, and/or by activating the flow control mechanism of the lower transmission protocol layer of the previous leg in the uplink direction, e.g. by mapping or converting the tunnelled flow control information into the flow control information according to the protocol of the next leg. In the latter case the lower layer protocol entity of the previous leg in the same node may stop forwarding new data to a leg not supporting the flow control, and/or the respective lower protocol entity at the far end of the previous leg may stop sending new data. In each case the data flow on the lower transmission protocol level of the leg not supporting the flow control can be controlled and the overflow of data buffers or discarding of data can be avoided in each leg of the end-to-end connection. As a result, the integrity of the data can be assured with the lower level flow control mechanisms only, without any need for high-level flow control. Also large buffers will be avoided. The inventive concept also allows, however, the use of a high-level protocol, such as the LAC, in one of the legs of the connection or over the whole end-to-end connection.

The flow control information may be tunnelled over the leg not supporting the flow control as in-channel signalling or in out-channel signalling associated with a connection.

In the preferred embodiment of the invention the connection leg not supporting the flow control is an ATM connection, and the lower transmission protocol level includes an ATM adaptation layer. In order to implement the in-channel signalling embodiment, flow control information may be inserted into the ATM adaptation layer service data unit which is then transported over the leg not supporting the flow control to the other end in accordance with an ATM network protocol. At the other end the flow control information is extracted from the ATM adaptation layer service data unit. In the preferred embodiment of the invention, the flow control information is inserted into the user data field of the ATM adaptation layer service data unit. The in-channel signalling approach is a very flexible and simple way to arrange the tunnelling of the flow control information. In the out-channel signalling approach, some modification in the signalling messages may be required, depending on the signalling system used.

### BRIEF DESCRIPTION OF THE DRAWINGS

The invention will now be described by means of preferred embodiments with reference to the attached drawings, in which

FIG. 1 shows a simplified UMTS architecture,

FIG. 2 illustrates the protocol stacks which may be used in a pure third generation mobile system,

FIG. 3 shows protocol stacks which may be used in a mixed 3G and 2G mobile system,

### PREFERRED EMBODIMENTS OF THE INVENTION

The preferred embodiments of the invention are described in the following as implemented in the third generation mobile system when the transport network is an ATM network. However, the aim is not to restrict the invention to these embodiments. The invention is applicable to be used in any telecommunications system in which an intermediate connection leg fails to support any lower level flow control mechanism while such a flow control mechanism is supported by the connection legs or equipment to which the intermediate leg is connected to. As used herein, the term leg may also refer to a user interface between a node and user equipment or application connected thereto.

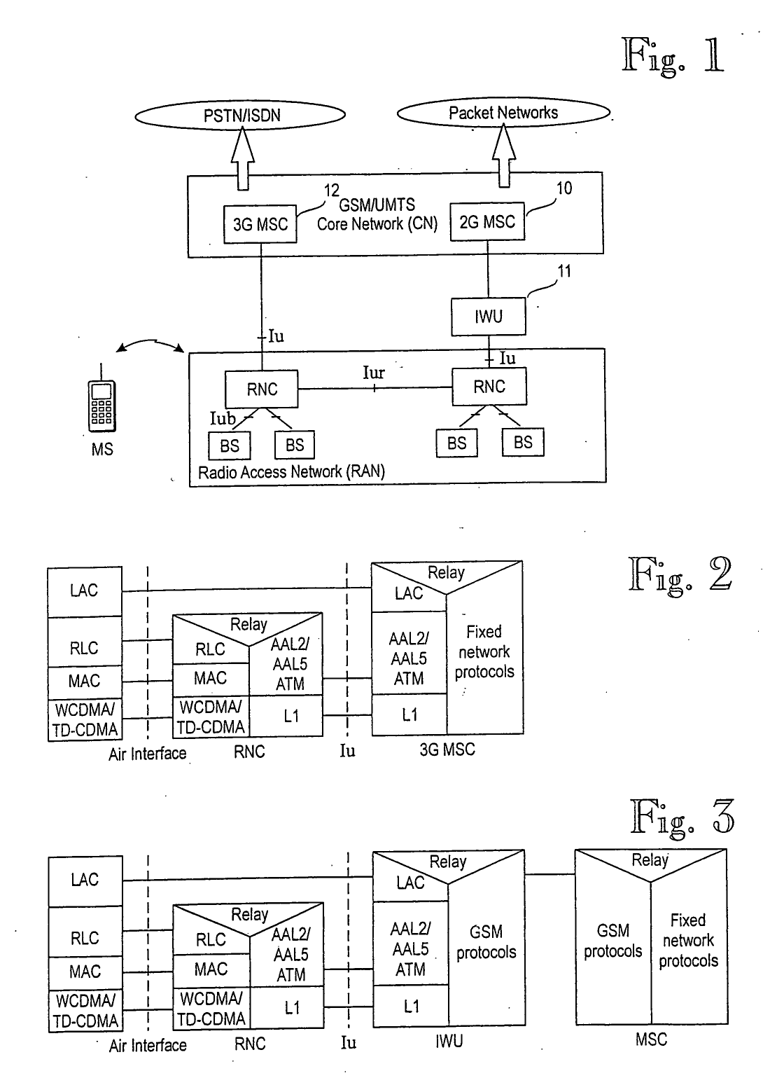

The architecture of the UMTS access network was described above with reference to FIG. 1, and examples of the protocol stacks were illustrated in FIGS. 2 and 3.

With reference to FIGS. 2 and 3, the relay layer in the RNC and in the 3GMSC or the IWU illustrates any high-layer protocols or entities required. In the UTRAN reference model as well as in the ATM reference model, these higher layers are defined to include a user plane and the control plane. In the UTRAN the control plane is further divided into a radio network control plane and a transport network control plane for radio network control and signalling. The transport network control plane is designed for the ATM based transport network in the interface lu. Both the standardized ATM connection control signalling (PNNI, UNI, BISUP) and AAL2/AAL5 signalling protocol are available. The user (the protocol entity) in the user or control plane has an access to the underlying ATM adaptation layer, or even to the ATM layer, through an ATM adaptation layer service access point (MUSAP) both in the RNC and in the 3GMSC (FIG. 2) or the IWU (FIG. 3). Thereby, the AAL service provides a capability to transfer ATM adaptation layer service data units (AAL-SDU) from one AAL-SAP to one other AAL-SAP in the interface lu through the ATM network. In the RNC the same user entity or a user entity it co-operates with has access to a RLC entity in the RNC-MS leg. In the 3GMSC the AAL-SAP user is the LAC and/or the interworking function on the relay level. The interworking function has access to a protocol employed on the lower transmission protocol level in a fixed network, such as V.120. Also in the IWU the AAL-SAP user is the LAC and/or the interworking function on the relay level. The interworking function has access to an entity in the lower level GSM protocol, such as RLP or RA (rate adaption), employed in the IWU-MSC leg in FIG. 3. In the 2GMSC the relay layer provides standard interworking between the GSM protocols and the fixed network protocols.

As noted above, the ATM leg does not support a flow control mechanism which would assure the data integrity. Therefore, in accordance with the present invention, the higher layer entities in the RNC, the 3GMSC and the IWU are provided with the capability to recognize a need for flow control in the ATM leg and to tunnel the associated flow control information over the ATM leg to the-high level entity at the transmitting end. The transmitting entity is arranged to implement the flow control in the ATM leg on the basis of the tunnelled information.

The invention relates to flow control in data transmission in telecommunications systems, particularly in wireless telecommunications systems. In the present invention flow control information is tunnelled over a connection leg which does not support flow control on a lower transmission protocol layer underlying a user level. The nodes at the both ends of the leg are arranged to use the flow control information to control the data flow on the lower transmission protocol level of the leg. In other words, the transmission of new data on the lower transmission protocol level is ceased or the data rate decreased when the flow control information activates the flow control in the transmitting node, and similarly, the transmission of new data on the lower transmission protocol level is restarted or the data rate increased when the conveyed flow control information deactivates the flow control.

The flow control mechanism may be a mechanism using Flow Control ON/Flow Control OFF type of flow control. In this case, when the flow control is set ON by the receiving network element on one side of the tunnel, e.g. in the RNC, the transmitting network element, e.g., the MSC, on the other side of the tunnel sends no data until flow control is set OFF. Alternatively, a dynamic flow control mechanism may be used. In this mechanism, the RNC tells the MSC to reduce the data rate when the need for flow control is recognized. For example, the data rate may be reduced to 75%, 50%, 25% or 0% of the nominal data rate of the connection.

In the following, the prefererred embodiments are described with the ON/OFF mechanism, but alternatively the dynamic flow control can be used in these embodiment.

The first embodiment of the invention in which the tunnelling is implemented by in-channel signalling will now be described.

Let us assume that data is transmitted from the mobile station MS to the 3GMSC and further to the fixed network in the system of FIG. 2. A RLC/MAC link with flow control is established between the MS and RNC. An ATM connection is established between the RNC and the 3GMSC. An LAC protocol link is established between the MS and the 3GMSC. A fixed network traffic channel using V.120 protocol is established between the 3GMSC and the other party in the fixed network.

The need for the flow control is recognized by the user of the AAL-SAP in the RNC or the 3GMSC. The need for the flow control can be recognized, for example, from the lower layer receiving or transmitting buffer status in the ATM leg or from the flow control request incoming from the following leg in the downlink, i.e. from the mobile station MS to the RNC or from the PSTN/ISDN to the MSC or IWU. According to the in-channel signalling approach of the present invention, a flow control request is provided by the user of the AAL-SAP upon detecting the need to activate or deactivate the flow control towards the ATM leg. The flow control request is packed into the AAL-SDU, preferably into the payload part of it. In the preferred embodiment of the invention the packing is performed in the service-specific convergence sublayer (SSCS) which is the uppermost sub-layer in the AAL layer and can be modified in this respect. The user of the AAL-SAP is arranged to, via the AAL-SAP, to command the SSCS to send the flow control ON request or the flow control OFF request, depending whether the flow control is to be activated or deactivated. Alternatively, the flow control information may be added to the user data prior to inputting the user data to the AAL layer in which case the user information will be inherently packed into the AAL-SDU. The AAL-SDU is transported through the AAL lower layers and the ATM layer to the other end of the ATM connection (e.g. from the RNC to the MSC or vice versa) as specified in the ATM specifications. The receiving AAL-SAP user or the SSCS sublayer extracts the flow control information from the received AAL-SDU. The received flow control information is used to implement the flow control. This may include mapping or converting the flow control information into the flow control request according to the previous leg (e.g. the MS-RNC or the MSC-fixed network) in order to activate or deactivate the flow control towards the previous leg. The implementation of the flow control may also include adapting the AAL-SAP user's own operations to the status of the flow control indicated by the received flow control information, e.g. stopping the sending of new data if the flow control request indicates that the flow control is active (ON), and restarting the sending of new data if the flow control request indicates that the flow control is deactivated (OFF).

There are several alternative ways for packing the flow control information into the AAL-SDU.

1) An octet carrying the flow control request (ON or OFF) is always inserted in the AAL-SDU, for example before the first user data octet. A receiving entity will always know that the first payload octet contains flow control information (and perhaps some other status/control information). This is applicable to all AAL types, i.e. AAL1, AAL2 and AAL5.

2) A bit or bits carrying the flow control request (ON or OFF) is/are always inserted in the AAL-SDU, for example before the first user data bits. The receiving entity will always know that the first payload bit(s) contain(s) flow control information (and perhaps some other non-user-data information). This is applicable to AAL type 1 operating in the non-structured mode, for example.

3) An octet or (a) bit(s) carrying the flow control information (and/or other status/control information) is inserted in the AAL-SDU as the only payload information, or with only a limited amount of user data in the payload, in order to make the whole payload fit in one or a limited number of ATM cells. In this way the flow control (and/or status/control) information must not be presented in all AAL-SDUs, but the flow control request is transmitted only when required. The AAL-SDUs carrying the flow control information is in a normal manner provided with a length indication, e.g. a length indicator in the AAL2 and AAL5, or a sequence number in the AAL1. The receiver is able to identify the AAL-SDUs carrying the flow control information by means of this length indication. A short AAL-SDU is carrying flow control and/or status/control information, whereas longer AAL-SDUs are carrying pure user data. This method is applicable to all AAL types.

In the octet based transmission (e.g. AAL5, AAL2) a whole octet is used to carry the flow control (and/or status/control) information, which means that the information can be protected by an error correcting code. This is useful in a service, such as AAL5, which allows corrupted SDUs to be delivered to the service user.

In one embodiment of the invention the user or control plane has access to the ATM layer. The flow control information is transmitted from/to the user or control plane to/from the ATM layer with interlayer primitives or messages. The ATM layer transports the flow control information to the peer ATM layer in an ATM cell. In addition to the flow control information, the cell will carry a connection identifier and cell or payload type identifier in order to enable the receiving ATM entity to deliver the information to the correct user or control entity.

There are several ways how an ATM cell can carry the required information, for example:
The payload type of an ATM cell is given a dedicated value, e.g. “Connection related information” or “Flow control information”. The VPI and VCI fields of the cell are used for the connection identifier (as usual in the ATM. The information field of the cell is used for carrying additional information, e.g. Flow Control ON, Flow Control OFF.
The payload type of an ATM cell is given a value “user data”. The VPI and VCI fields of the cell are given a dedicated value, e.g. “Connection related information” or “Flow control information” or “Signalling information”. The information field of the cell is used for carrying the connection identification and additional information, e.g. Flow Control ON, Flow Control OFF.

According to the second aspect of the invention, the flow control information is tunnelled over the ATM leg in out-channel signalling, i.e. using a control plane message.

The user plane protocol entity in the RNC, i.e. MAC/RLC user entity, or in the MSC, i.e. a fixed network protocol user entity, or in the IWU, i.e. a GSM protocol user entity, recognizes the need for flow control towards the ATM leg of the connection. The recognition may be based on the buffer status or the flow control information received, for example. The user plane protocol entity then indicates the need of the flow control to the call control and signalling entity in the control plane, e.g. by sending a “flow control required in this connection” message with parameters identifying the connection or channel in question.

The control plane sends the flow control request in an out-of-band signalling message associated with the connection to the peer signalling entity behind the ATM connection. In other words, the RNC sends a message to the MSC or the IWU, and the MSC or the IWU sends a message to the RNC. The type or format of the message depends on the signalling system used.

If the ATM user-to-network interface signalling (UNI) is employed, a connection related STATUS message can be used, for example. Only new status parameters values, such as “flow control ON” and “flow control OFF”, are defined in the STATUS message. The UNI is defined in the ITU-T Q.2931 which also defines the STATUS message. There are unused parameters values in the STATUS message according to the Q.2931 which can be used for the purpose of the invention.

If the ATM network to network interface signalling (NNI) according to the recommendation ITU-T Q.2763 is used, the user to user signalling (UUS) message, for example, can be used for carrying the flow control information according to the invention.

If another kind of signalling, such as RAN-MAP, is used, a corresponding connection associated message can be employed to transport a flow control ON/OFF request to the peer signalling or call control entity. Because the RAN-MAP is currently under specification, it is easy to specify flow control parameters for a message or even a dedicated message for this purpose. The receiving signalling and call control entity extracts the flow control request from the received signalling message and forwards it to the relevant user plane control entity. The user plane control entity employs the flow control request for implementation of the flow control. For example, the user plane control entity may map the flow control request to the flow control mechanism of the protocol of the previous traffic channel leg, e.g. to the MAC/RLC in the RNC, or to the GSMRLP or GSMRA in the IWU, or to the ISDN V.120 in the MSC, in order to thereby activate or deactivate the flow control towards the previous leg.

The invention was described above in embodiments using circuit-switched connections. However, the invention can also be applied in conjunction with packet data services.

The invention should not be limited to the specific examples described herein. Rather, the spirit and the scope of the invention should be construed in accordance with the claims attached hereto.

1. A data transmission method in a telecommunications system, comprising:
transmitting data over a connection including a first leg supporting flow control on a lower transmission protocol level underlying a user level, an intermediate second leg not supporting flow control on the lower transmission level, and a third leg supporting flow control on the lower transmission protocol level,
tunnelling lower level flow control information through the lower transmission protocol level of the second leg between the first and third legs in order to provide end-to-end flow control and thereby data integrity over the connection on the lower transmission protocol layer.

2. The method of claim 1, wherein the second leg is an ATM connection, and the lower transmission protocol level includes an ATM adaptation layer.

3. The method of claim 2, comprising:
encapsulating the flow control information in an ATM adaptation layer service data unit,
transporting the ATM adaptation layer service data unit to the other end of the second leg in accordance with an ATM network protocol, extracting the flow control information from the ATM adaptation layer service data unit at the other end of the second leg.

4. The method of claim 1, wherein the second leg is an ATM connection and further comprising tunnelling the low control information in ATM cells in an ATM layer through the ATM connection.

5. A telecommunications system, comprising:
a first connection leg supporting flow control on a lower transmission protocol level underlying a user level,
an intermediate second connection leg not supporting flow control on the lower transmission level,
a third connection leg supporting flow control on the lower transmission protocol level,
a first node between the first and second legs,
a second node between the second and third legs,
wherein the first and second nodes are arranged to tunnel lower level flow control information through the lower transmission protocol level of the second leg between the first and third legs to provide end-to-end flow control and thereby data integrity over the connection on the lower transmission protocol layer.

6. The system of claim 5, wherein the second leg is an ATM connection, and the lower transmission protocol level includes an ATM adaptation layer.

7. The system of claim 6, wherein the first and second nodes are arranged to insert the flow control information in an ATM adaptation layer service data unit.

8. The system of claim 6, wherein the second leg is an ATM connection, and the first and second nodes are arranged to tunnel the flow control information in ATM cells in an ATM layer through the ATM connection.

9. The system of claim 5, wherein the system is a mobile communications system, and the first and second nodes are network elements of the mobile communications system, and the first leg is at the air interface between a mobile station and one of the network elements.

10. A network node for a telecommunications system, the network node being configured to relay communication between a first connection leg supporting flow control on a lower transmission protocol level underlying a user level on a first connection leg, and an intermediate second connection leg connected to a second network node relaying the communication further to and from a third connection leg supporting flow control on the lower transmission protocol level, and wherein the second leg does not support flow control on the lower transmission level, and wherein the network node is configured to tunnel lower level flow control information through the lower transmission protocol level of the second leg between the first and third legs to provide end-to-end flow control and thereby data integrity over the connection on the lower transmission protocol layer.

11. The network of claim 10, wherein the second leg is an ATM connection, and the lower transmission protocol level includes an ATM adaptation layer.

12. The network node of claim 11, wherein the node is configured to insert the flow control information in an ATM adaptation layer service data unit.

13. The network node of claim 12, wherein the second leg is an ATM connection, and wherein the node is configured to tunnel the flow control information in ATM cells in an ATM layer over the ATM connection.

14. The network node of claim 10, wherein the system is a mobile communications system, and the node is a network element of the mobile communications system.

15. The network node of claim 10, wherein the first leg is at the air interface between a mobile station and the network element.

16. The network node of claim 10, wherein the network node is a radio network controller.

17. The network node of claim 10, wherein the network node is an interworking unit.

18. The system of claim 5, wherein the first and second nodes are arranged to recognize a need to start or stop flow control towards the second leg and to send a flow control ON request or a low control OFF request, respectively, over the second leg, and the first and second peer entities are responsive to receiving the flow control ON request or the flow control OFF request for activating or deactivating, respectively, flow control towards the first or the third leg.
